(19) United States
(12) Patent Application Publication
(10) Pub. No.: US 2014/0108961 A1
(43) Pub. Date: Apr. 17, 2014

(54) SYSTEM AND METHOD FOR ESTABLISHING CULTURAL CONNECTIONS WITHIN AN ONLINE COMPUTER SYSTEM SOCIAL MEDIA PLATFORM

(71) Applicant: FREDERICK SUNDSTEN, Orlando, FL (US)

(72) Inventor: FREDERICK SUNDSTEN, Orlando, FL (US)

(21) Appl. No.: 13/653,859

(22) Filed: Oct. 17, 2012

(51) Int. Cl. G06F 3/01; G06F 15/16

(52) U.S. Cl. 715/753

(57) ABSTRACT

A system and method for establishing connections between users of a social media platform includes establishing communication with a user interface, receiving identifying and cultural information, providing the information to a database and providing search options based on the cultural information. The system and method can also display search results in the form of a map showing the geographic location of the search results.

### TECHNICAL FIELD

The present invention relates generally to social media networks, and more particularly to a system and method for identifying cultural connections and establishing relationships within a social media environment.

### BACKGROUND

The statements in this section merely provide background information related to the present disclosure and may not constitute prior art.

Social media websites sites have changed the way people stay in touch. To this end, conventional social media sites typically incorporate a user defined page having information and/or messages from one person that is available to select other individuals who are also members of the site. While this arrangement serves to maintain existing relationships utilizing new technology, it does not lead to making new friendships and/or connections.

To this end, new connections between individuals using the conventional social media websites are often established after there is some real life connection. For example, classmates, co-workers or soccer moms may establish social media groups to share and expand their existing relationships. Likewise, celebrities often create social media pages to allow their fan base to follow current events pertaining to the celebrity.

Although this process works well to maintain existing relationships, conventional social media sites do not provide an ideal environment for establishing new connections between individuals who are not already affiliated. Such a feature can be extremely desirable for individuals who have relocated to a different area, students attending an out of town university, or businesses attempting to offer products to a particular section of the population.

Although each of the above situations may involve individuals with different likes and interests, society has proven that by establishing some form of underlying bond, such as a cultural connection, for example, individuals are much more likely to quickly establish and maintain long lasting friendships.

Accordingly, it would be beneficial to provide a system and method for establishing cultural connections within an online computer system social media platform.

### SUMMARY OF THE INVENTION

The present invention is directed to a system and method for establishing connections between users of a social media platform based on cultural information. One embodiment of the invention can include a method capable of establishing communication with a user interface, to receive identifying and cultural information. Once received, the information can be added to a database containing cultural information of other users. Options are provided for suggesting new contacts based on the cultural information, and for allowing users to search based solely on the cultural information. Search results can be displayed on a map showing the geographic location of the other users.

Another embodiment of the present invention can be directed to a system and a non-transitory computer readable storage medium for performing the above identified method.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is a simplified block diagram of a system for establishing connections between users of a social media platform based on cultural information that is useful for understanding the inventive concepts disclosed herein.

FIG. 1a is a cutout block diagram of an application system for use with the system of FIG. 1, in accordance with one embodiment of the invention.

FIG. 2 is a block diagram of a database in accordance with one embodiment.

FIG. 3 is an exemplary display screen in accordance with one embodiment.

FIG. 3a is another exemplary display screen in accordance with one embodiment.

FIG. 4 is another exemplary display screen in accordance with one embodiment.

FIG. 4a is another exemplary display screen in accordance with one embodiment.

FIG. 5 is another exemplary display screen in accordance with one embodiment.

FIG. 6 is another exemplary display screen in accordance with one embodiment.

FIG. 7 is another exemplary display screen in accordance with one embodiment.

FIG. 8 is another exemplary display screen in accordance with one embodiment.

FIG. 9 is another exemplary display screen in accordance with one embodiment.

FIG. 9a is another exemplary display screen in accordance with one embodiment.

FIG. 9b is another exemplary display screen in accordance with one embodiment.

FIG. 9c is another exemplary display screen in accordance with one embodiment.

FIG. 10 is a flow chart illustrating a method for allowing a user to access the social media platform search for other community members, and communicate with the same, in accordance with one embodiment of the present invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

As will be appreciated by one skilled in the art, aspects of the present invention may be embodied as a system, method or computer program product. Accordingly, aspects of the present invention may take the form of an entirely hardware embodiment, or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon. In either instance, the system and other computer hardware will be necessary to, and integral in the transformation of user supplied information into a social media platform represented by maps, icons, user defined pages, and other such information.

Program code embodied on a computer readable medium may be transmitted using any appropriate medium, including but not limited to wireless, wire-line, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like, and/or conventional procedural programming languages, such as the “C” programming language or similar programming languages, for example. The program code may execute entirely on one or more user devices such as a computer, for example, partly on the user's computer, as a stand-alone software package, partly on the user's computer and partly on a remote computer or entirely on the remote computer or server. In the latter scenario, the remote computer may be connected to the user's computer through any type of network, including a local area network (LAN), or a wide area network (WAN), or the connection may be made to an external computer, for example, through the Internet using an Internet Service Provider.

As described throughout this document the terms “user” and “member” are used interchangeably to describe any person or entity utilizing the system to communicate with others in a social media platform setting. Additionally, the terms “site owner” and “system management” are used interchangeably, and can include an individual or legal entity that is performing the method and/or system described below. In one preferred embodiment, a system and method for establishing cultural connections within an online computer system social media platform will be entitled “Global Friend Finder” and can be performed on a website entitled “GloFinder.com”. Of course, this is for illustrative purposes only, as the below described functionality can be performed in any number of different manners, websites, website URL's and/or computer networks. Additionally, it is contemplated that some or all of the functionality described herein can also be performed simultaneously via different websites that are directed towards individual markets and/or geographic locales. Such functionality can be performed under the direct supervision of the original site owner, or via secondary site owners through a franchise, licensing or other type of arrangement.

A method and system is provided for establishing connections based on cultural similarities between individuals using a social media platform. To this end, users will be provided access to a website and/or database system that can feature an advanced search engine capable of allowing users to search for other individuals based on cultural information. As described herein, the term “cultural information” can include virtually any type of information pertaining to a user's past and present, likes, interests, traits and physical characteristics. Several non-limiting examples include: places of origin such as cities, states, countries, nationalities, or world region; languages spoken; religion; regions of historical interest; current location/residence; socioeconomic similarities; race and ethnicity; places visited and the like.

To this end, the described method and system can allow individuals to connect with other members and businesses who speak the same language, live in close proximity, originate from the same country or have resided in related countries. As will be described below, the system and method can act to identify cultural connections between members based on profile information provided by the site members at the time of registration. In one preferred embodiment, all user-provided information will be private by default, and each user will be able to specify what information is available to be viewed by other members (public information).

In either instance, each user can be assigned to an initial group based on their geographic location when logging into the site. As will be described below, the system can generate a map and/or chart wherein some or all of each users' public information can be displayed to other users who are in the same group. Such a feature can act to notify group members of other individuals having similar cultural information who are located nearby.

Additionally, users can search other group locations. For example, if a user plans to visit another country or location and would like to connect with, or make new friends at that location, they can search the group of members corresponding to the area they plan to visit. To this end, the system can display a map based search result, list and grid view layout for easy and intuitive navigation. Each user can also have an individual profile which can allow them to search for, and be found by other users, so as to foster new relationships and to connect with businesses & organizations which are also registered to the site.

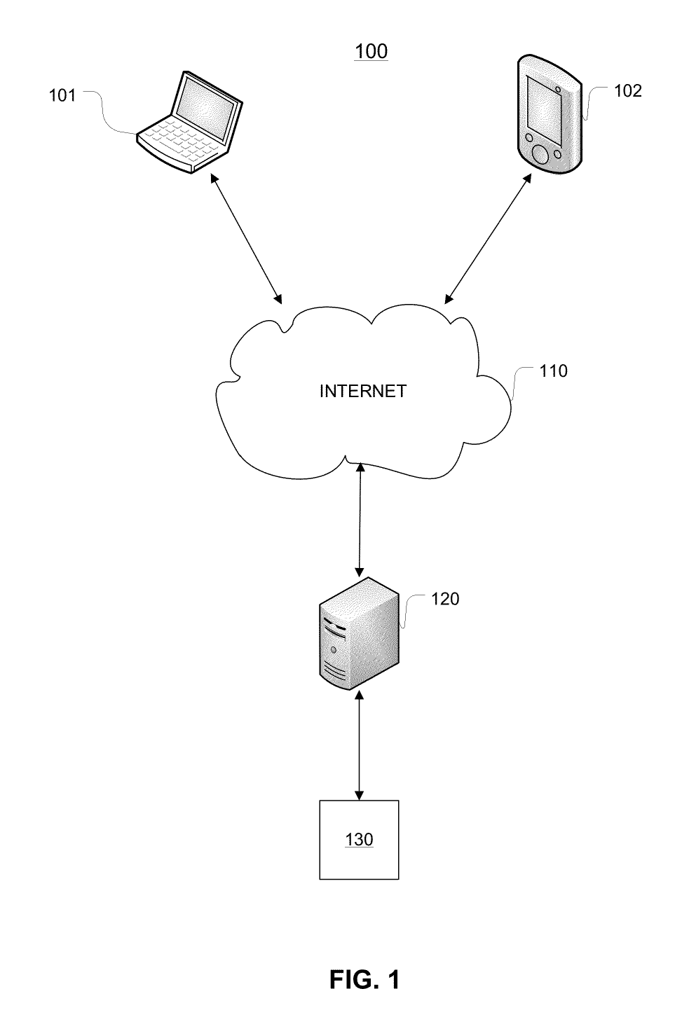

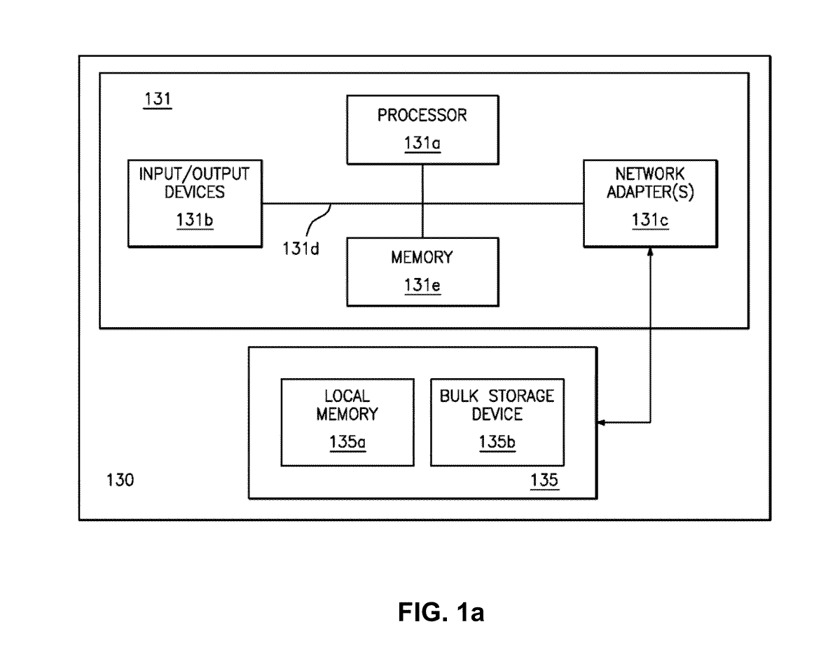

FIG. 1 illustrates a general architecture of a system that operates in accordance with one embodiment of the present invention. The system 100 can function to create an online computer based social media platform through which cultural connections between users can be identified and established to allow users to communicate in the manner described below.

As shown in FIG. 1, the system 100 can include a plurality of interface devices 101 and 102 connected to a database system 130 via an interface gatekeeper 120 and a network such as the internet 110. The user interfaces 101 and 102 will preferably comprise conventional computers, smart phones or tablet devices, but may also include any mechanism by which a user enabled processor or similar device can obtain and provide data, respectively, to or from the database system 130 of the present invention.

The interface devices 101 and 102 may be configured to display information in the form of text or a graphic user interface, respectively, that pertains to the social media website. The interface gatekeeper 120 may be a server or other such device for determining user access to the various portions of the database system 130.

As shown in cutout FIG. 1a, the database system 130, according to one embodiment, can include an application server 131 and a database 135. The application server 131 can preferably include a server or other such device responsible for generating content as well as exchanging information with the database 135, the gatekeeper 120 and each of the interface devices 101 & 102. As shown, the server 131 can include at least one processor 131a coupled to memory elements 131e through a connection device such as a system bus 131d. The system 130 can store program code within memory elements 131e which can be accessed by the processor 131a via the system bus 131d. In one aspect, for example, server 131 can be implemented as a computer that is suitable for storing and/or executing program code. It should be appreciated; however, that server 131 can be implemented in the form of any system comprising a processor and memory (integrated or separate) that is capable of performing the functions described within this specification.

One or more input/output (I/O) devices 131b such as keyboards, display monitors, and pointing devices can be coupled to system 130 either directly or through intervening I/O controllers. Likewise, one or more network adapters 131c can also be coupled to the system 130 in order to allow the system to connect to other devices such as the user interfaces 101 and 102. The network adapter can communicate via any number of known transport mechanisms such as the internet and/or private or public networks. Modems, cable modems, and Ethernet cards are non-limiting examples of different types of network adapters that can be used with system 130.

Memory elements 131e and database 135 can each include one or more physical non-transitory memory devices such as, for example, local memory 135a and one or more bulk storage devices 135b. Local memory 135a refers to random access memory or other non-persistent memory device(s) generally used during actual execution of the program code. Bulk storage device(s) 135b can be implemented as a hard drive or other persistent data storage device. Server 131 also can include one or more cache memories (not shown) that provide temporary storage of at least some program code in order to reduce the number of times program code must be retrieved from bulk storage device 135b during execution.

Although described above as utilizing a separate interface gatekeeper 120, application server 131 and database 135, one of skill in the art will recognize that these need not be separate components. Moreover, it is noted that the above description of the server 130 can also describe the functioning components for one or more of the gatekeeper 120 and/or the system interfaces 101 and 102.

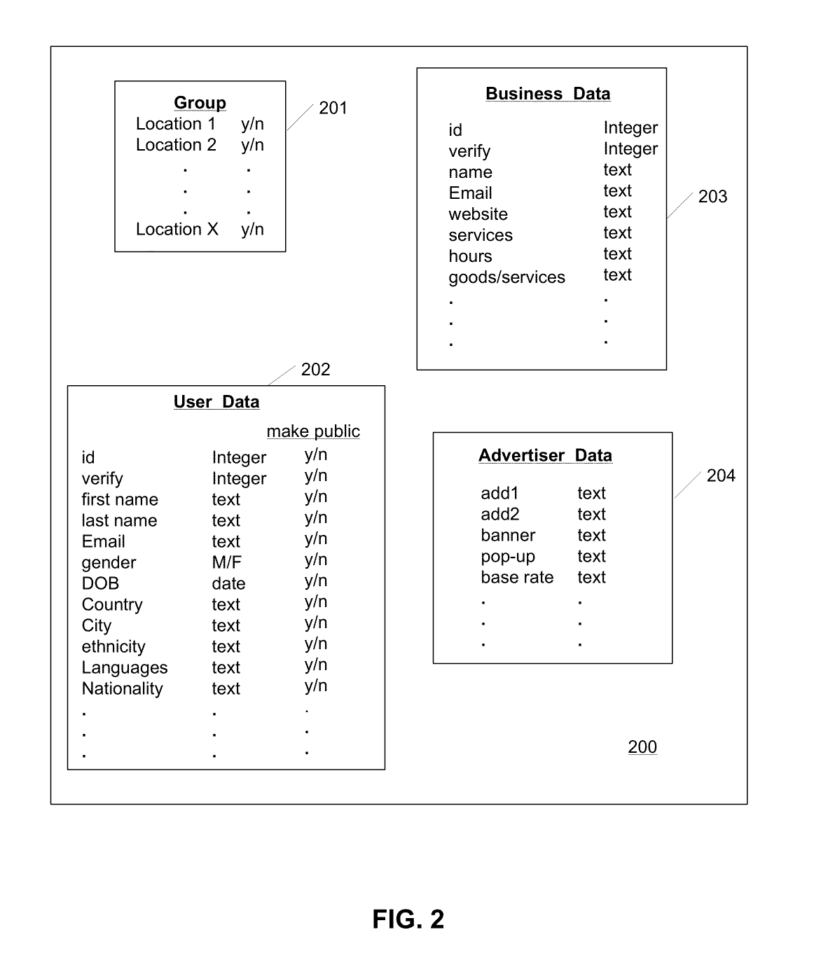

FIG. 2 illustrates a simplified block diagram of exemplary data 200 that may be stored within the system database 135. According to this non-limiting embodiment, registered users of the social media site may be subdivided into geographic networks/groups 201 based upon predetermined criteria such as the users current city of residence, origin and/or other such information. As will be described below, each user may also choose to join additional groups based on shared interests and the like. This secondary group data can also be stored in the memory. Further, the database may include specific information pertaining to each user. This user information 202 can include a combination of private, public and/or cultural information which can be utilized by the system to generate connections between members. Additionally, the database can include business data 203 pertaining to businesses having a site presence, and offering services to site users, and/or advertiser data 204 pertaining to paid advertisements listed on the site.

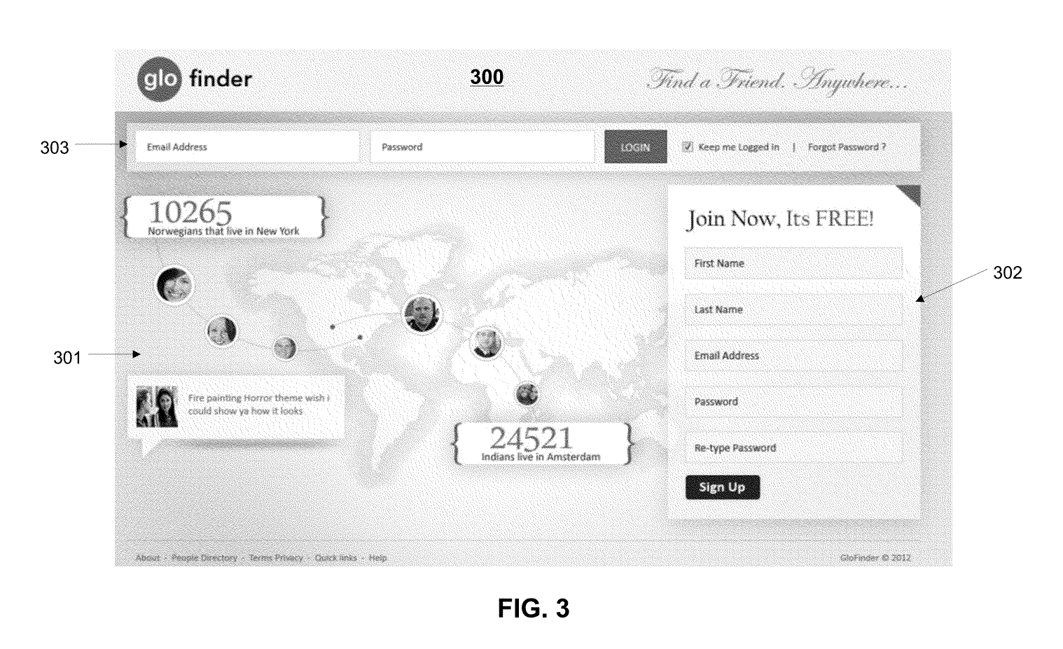

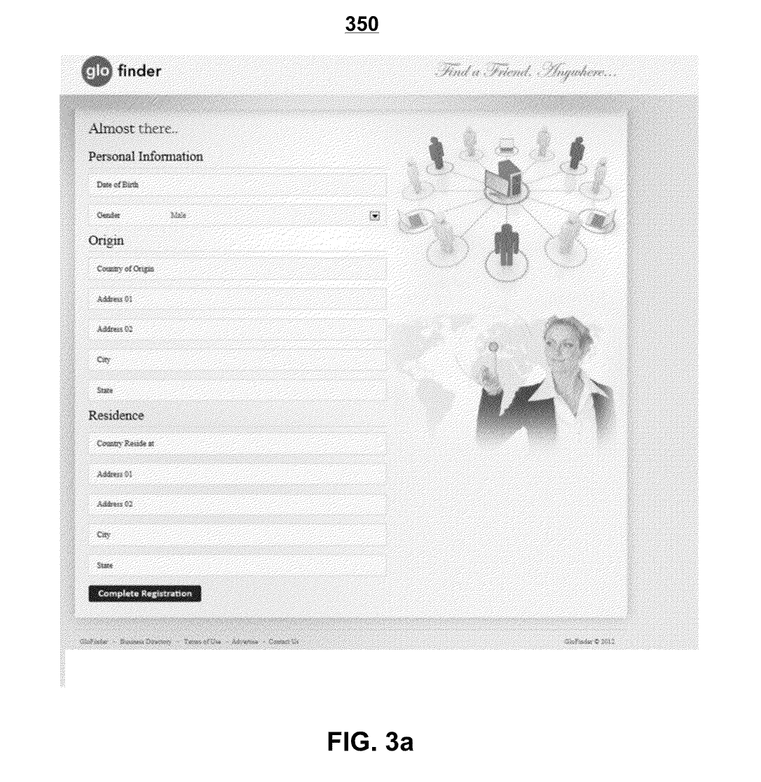

FIGS. 3-9 below present exemplary presentation screens which can be generated by the system and accessed by users in the form of a website and website pages. However, as described above, the particular system and method steps are not limited to such an arrangement, as those of skill in the art will recognize that any number of different and/or additional system components, method steps and/or content delivery mechanisms can also be provided without deviating from the scope and spirit of the inventive concepts disclosed herein.

FIG. 3 illustrates an exemplary presentation screen generated by the application system 130 to be displayed to a user on an interface device 101 or 102. In this example, an opening page 300 is generated in response to a user navigating to the website URL. This opening screen 300 can include information for encouraging membership by providing a brief synopsis of information contained in the site, and the potential benefits of accessing the same. For example, the screen may list basic information pertaining to how the system identifies cultural connections between members and may also provide statistics showing a snapshot of information pertaining to the area in which the website visitor is located 301. The system can determine the website visitors location based on the IP address of the visitors computer or other identifying features as are commonly known in the art. Additionally, the screen may provide options for registering new users 302, or for allowing previously registered members to log in 303.

If the user has not previously registered with the system, the user can be taken to a registration page where they can register to use the system. FIG. 3a, illustrates one non-limiting example of a user registration page 350, where the user may be required to provide identifying information such as: a name, username, password, date of birth, and other basic information necessary to establish a minimum site presence for the user. Additionally, the system may require the user to provide cultural information such as their nationality, country/state of residence, languages spoken, etc. When such information is collected, the user will be given the option to specify what cultural information is available for other members to view.

Upon registration, or logging in, the gatekeeper 120 can grant the user access to the system database 135 in order to view information about other members and to access system functionality. The system can also generate a user profile page to act as a personal page for each user wherein they can use the site features and manage their site presence. To this end, the profile page can allow users to specify what information about themselves will be available to other site users, and what information is to be held private. Additionally, the profile page can allow users to view and select one or more group networks based on their geographic location, languages spoken and/or nationality, for example, as well as to establish notification preferences regarding what types of communication from other members are to be received.

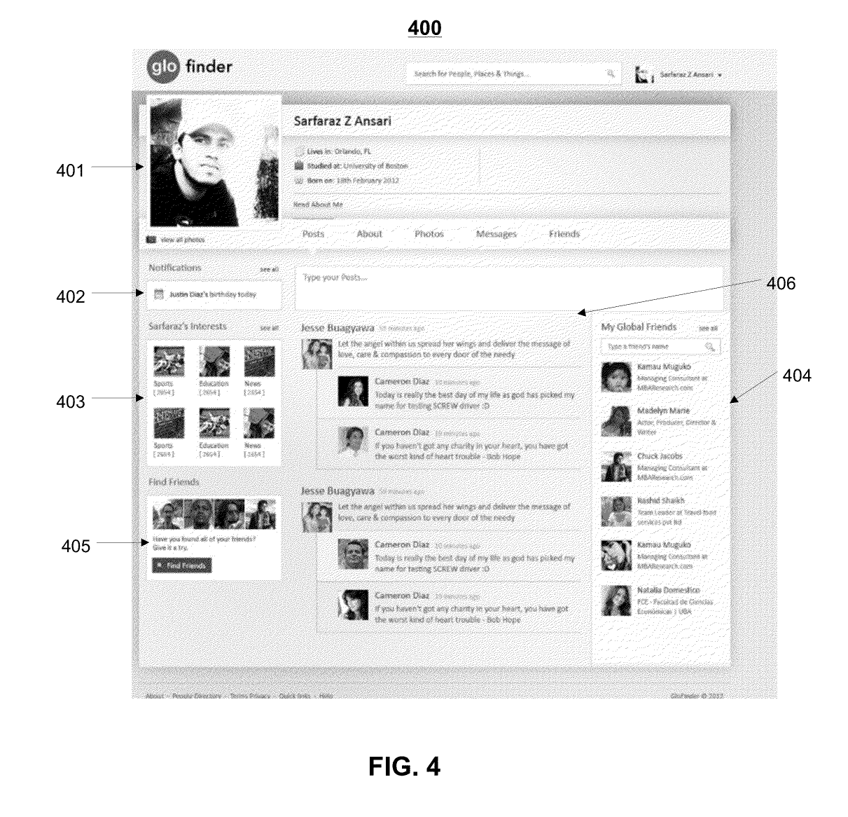

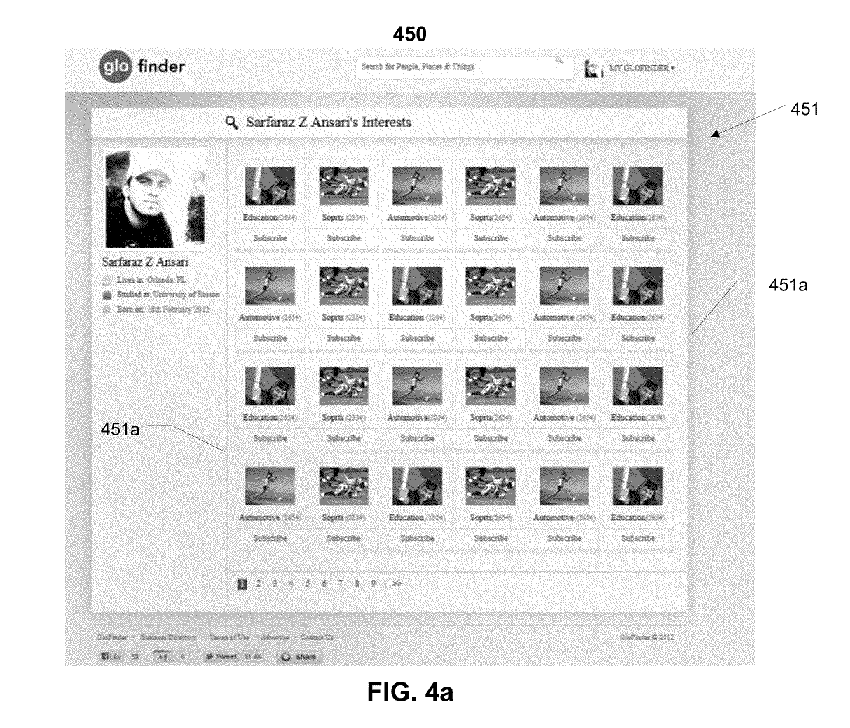

FIG. 4 illustrates one non-limiting example of a user's personal profile page 400 that is generated by the system in response to the user information provided during the registration process. As shown, page 400 can also include options for allowing a user to upload their avatar and other information 401, display notifications of upcoming events or happenings 402, display a list of pre-defined interests and/or cultural information 403, display a list of the users global friends 404, display a list of suggested friends 405 which can be produced automatically by the system based on each users public information, and display a list of recent posts 406 from other site members.

As described herein, the system can act to automatically compare the cultural information of all members together and generate the list of suggested friends based on this comparison. In one embodiment, the system can establish a minimum threshold for generating the list. For example, in one embodiment, the minimum threshold could require that at least three separate pieces of cultural information match before making the suggestion (e.g., languages, nationality and birthplace, for example). Of course, this is for illustrative purposes only, as the minimum threshold can be adjusted up or down, and can also be specified by the user with regard to their preferences for new suggested friends.

In one embodiment, user posts 406 can include communications that are displayed in a user's publically viewable space and may, therefore be visible to other site members. Additionally, the page can allow each user to create one or more business listings 406 on the site which can serve as a means for advertising business related products and services to other site members.

If the user selects the “see all” tab of the interests section 403, the system can generate a page containing a variety of groups pertaining to a particular interest. As shown in FIG. 4a, the “Interests” page 450 can include a series of pre-defined categories 451 spanning a wide variety of user interests and cultural information. These categories can include the cultural information described above, as well as more global user interests such as education, sports, automotive, science, hobbies and the like. Upon subscribing 451a to one or more of the provided categories, the system can link or otherwise associate the user's public profile with other site members who belong to the selected groups.

As will be described below, the system can also generate a list map and/or chart showing the geographic location of one or more of the other group members. For example, if the user joins a sports group for a particular sports team, the site can link the public user profile of each group member, and then provide a map showing the location of all group members within a user specified geographic area.

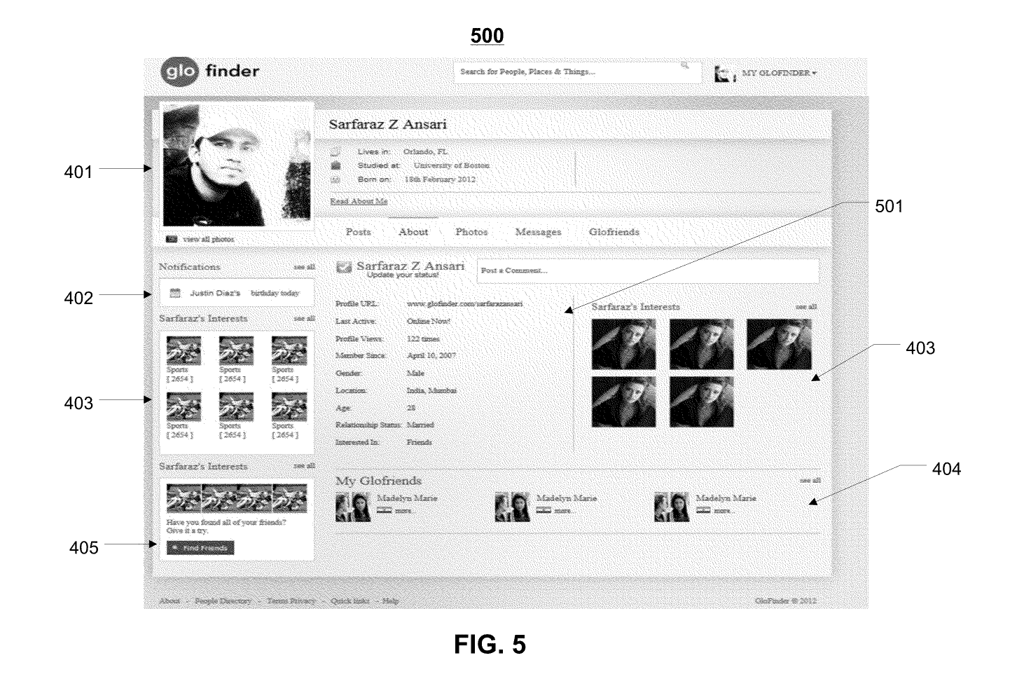

FIG. 5 illustrates one embodiment of a user's “About” page. In one preferred embodiment, the “About” page 500 can be generated by the system and can act as a public profile page for the member. The page can include information from the user's personal profile page 400 that is marked as public, so as to be available to other site members. Such information can be utilized by other site members to learn about the user and to establish relationships based on shared criteria. As shown, the about page 500 can also include user statistics 501 such as last active, profile views, membership date, and other information relevant to the user.

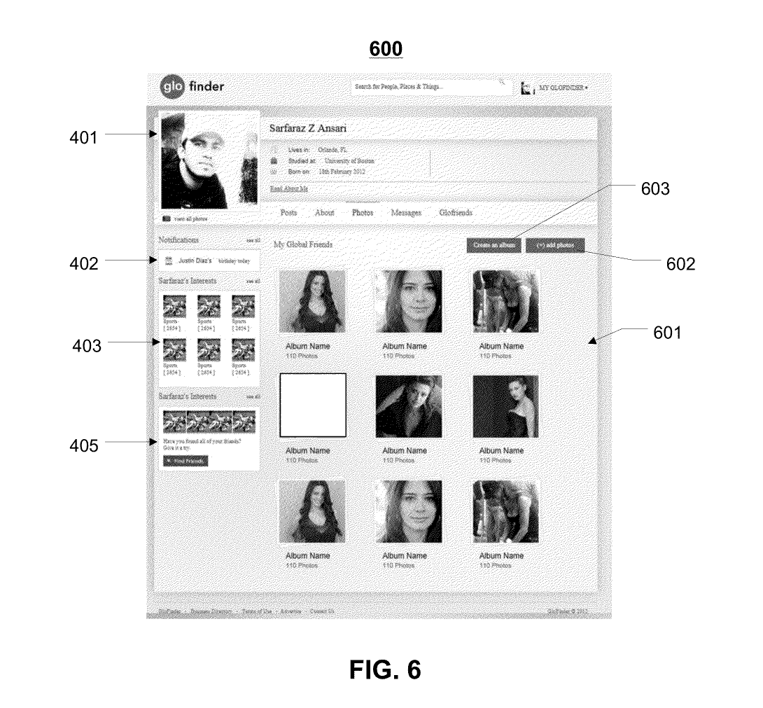

FIG. 6 illustrates one embodiment of a user's “Photo” page. As shown, the photo page 600 can include a listing 601 of photos, illustrations, and other such items which can be uploaded 602 by the user, or sent to the user by other site members. Options for arranging the photos into albums 603 can also be provided, in order to allow the user to easily manage their stored documents. Although described above as pertaining to photographs, other embodiments are contemplated. For example, the site can also include options for storing various types of saved multimedia. As with all user information, the user can decide which of the photo page contents are available to others.

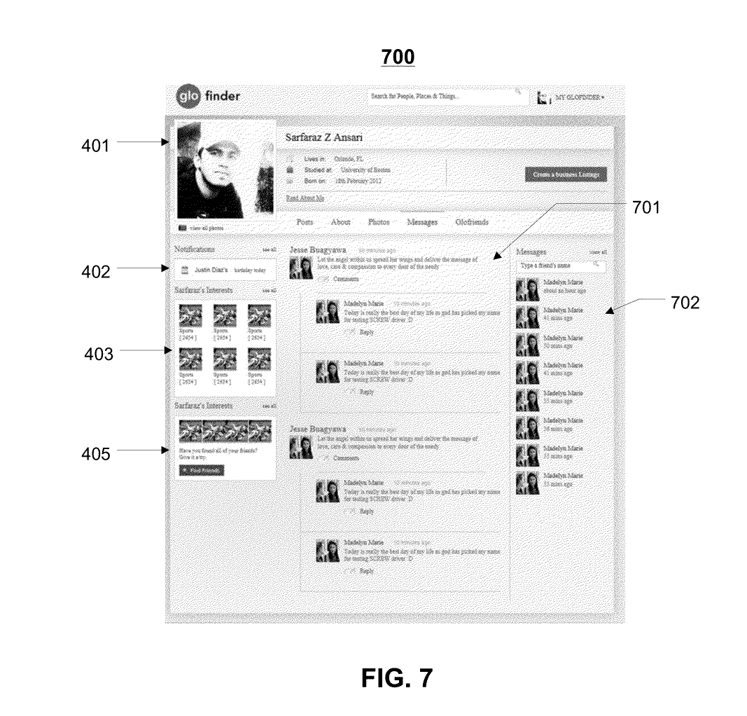

FIG. 7 illustrates one embodiment of a user's “Messages” page. As shown, the messages page 700 can provide the user with a message interface 701 for privately communicating with other site members. Additionally, the system can include a list of friends 702 to facilitate easy communication. These messages can include instant messages, email and other known communication mechanisms for allowing individuals to communicate in a social media setting.

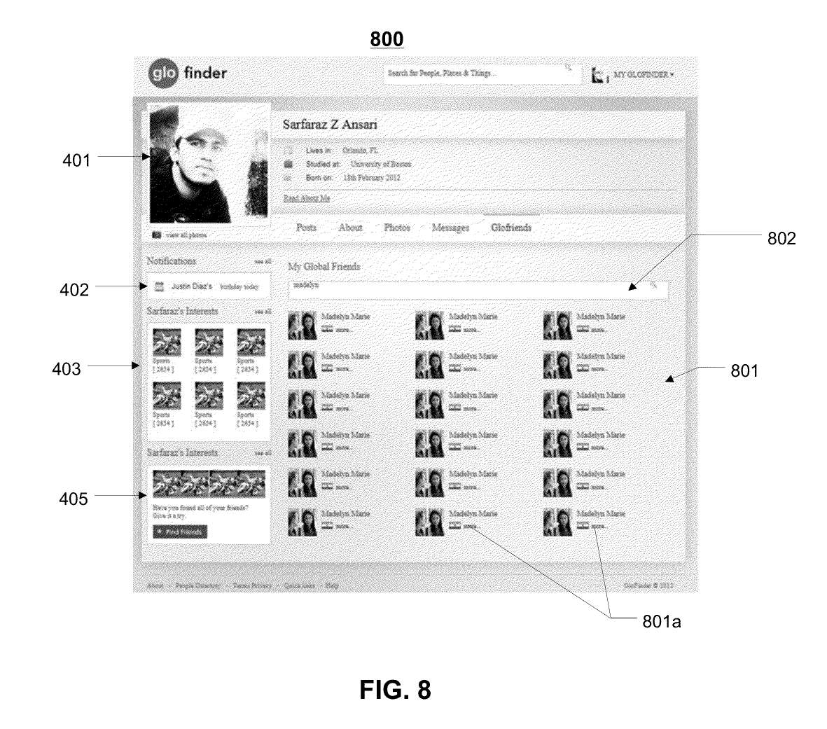

FIG. 8 illustrates one embodiment of a user's “Glofriends” page. As shown, the Glofriends (i.e., Global friends) page 800 can include a listing of previously established relationships 801, and clickable links 801a for viewing their public profiles. Additionally, the page can include functionality for allowing users to search 802 for other members based on their name or other identifying information.

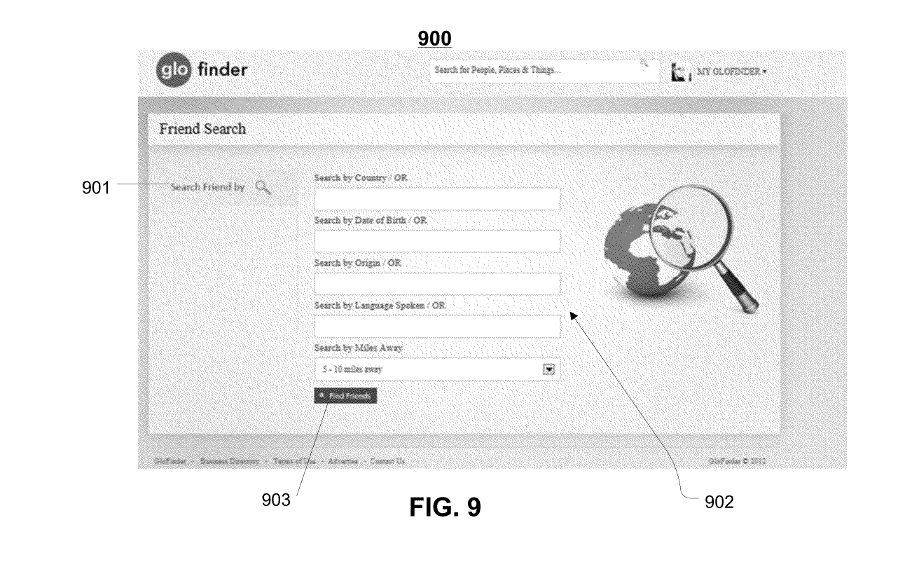

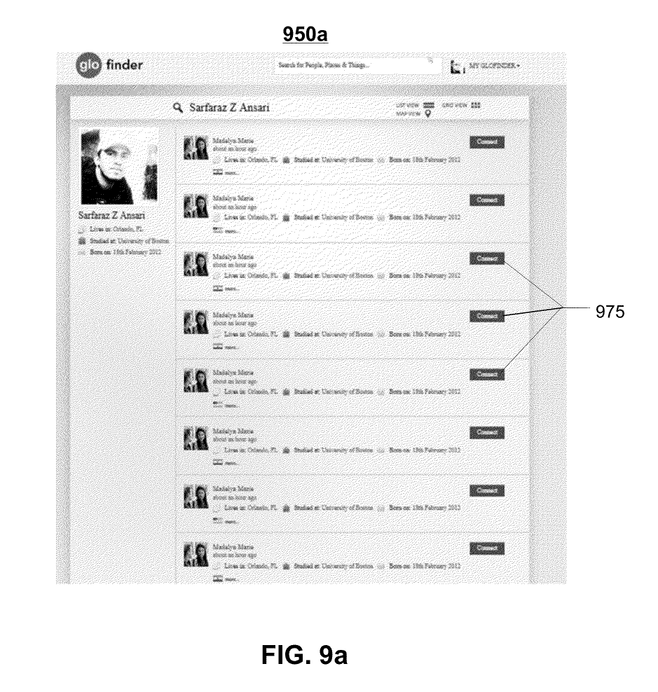

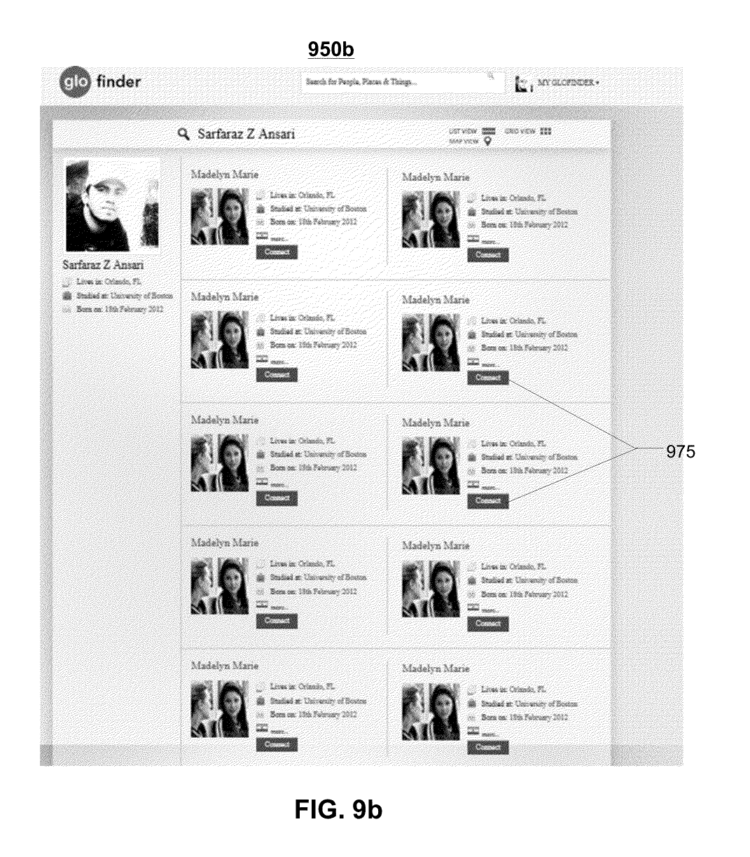

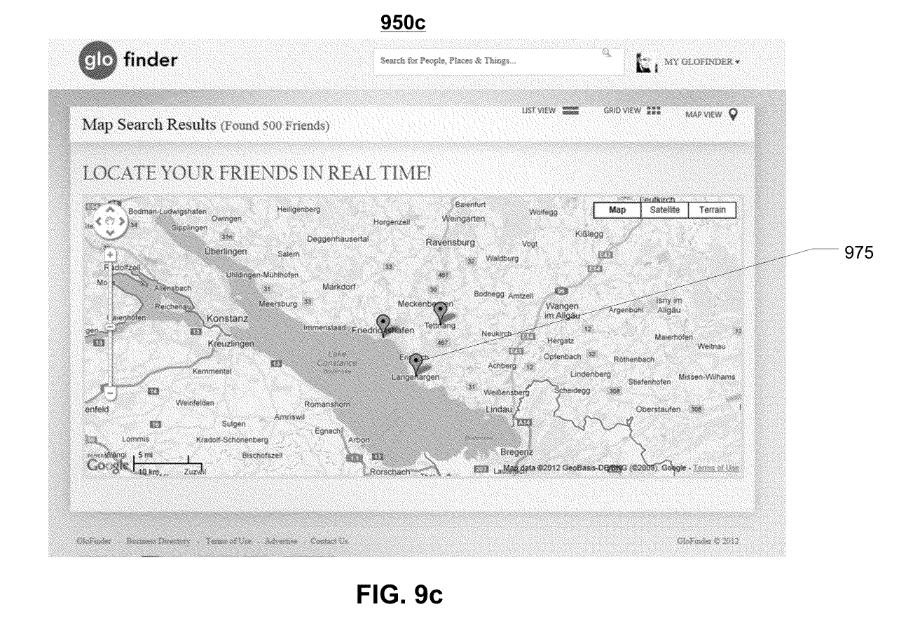

In another embodiment, the system can further provide functionality for allowing a user to make new contacts based on cultural information and/or shared interests. To this end, FIG. 9 illustrates one embodiment of a search screen 900 wherein users can search 901 for other members based on specific cultural criteria 902. Once selected 903, the system can search the database for matches based on the public information of other site members and display the search results of those members matching the entered criteria. The search results can be presented to the user in any number of different manners such as a list view 950a in FIG. 9a, a grid view 950b in FIG. 9b, or a map view 950c in FIG. 9c.

Regardless of the manner displayed, the site can direct the user to the public profile of each user meeting the criteria, and provide contact links 975 for establishing communication through the site.

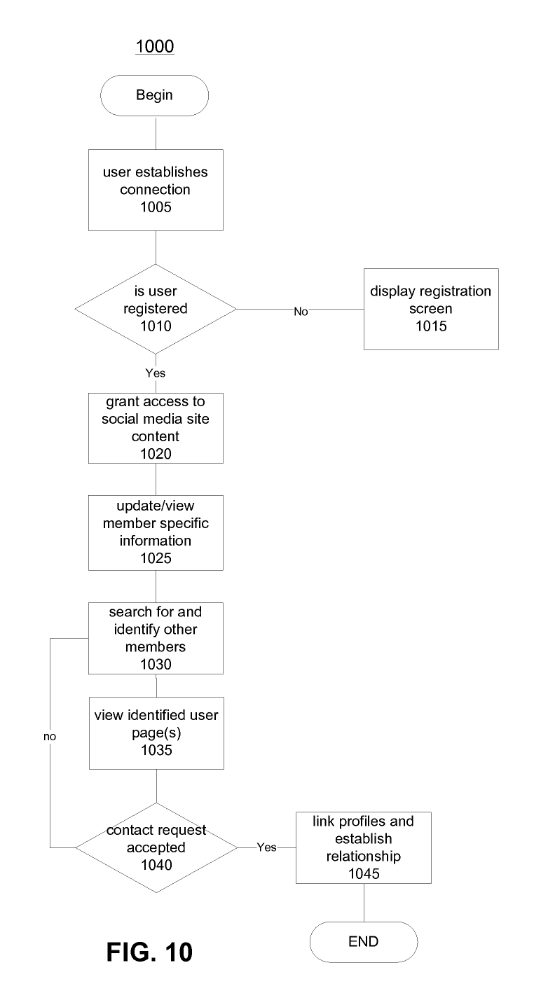

FIG. 10 illustrates an exemplary flowchart diagram of one embodiment of a method 1000 for establishing connections based on cultural similarities between individuals using a social media platform, and utilizing the system 100 described above.

Accordingly, the method can begin at step 1005 wherein a user activates an interface device 101 or 102 to establish communication with the interface gatekeeper 120 via the internet by selecting the URL for the social media site generated by the application system 130.

In step 1010 the application system can display an opening page, and can prompt the user to identify themself as a registered user by entering their username and password. If the information submitted is correct, the registered user is provided access to the system database 135 in step 1020. If the user does not have a username or password, then they can be directed to the registration page in step 1015 where the user can provide basic information in order to allow the application system to create a user profile page. Upon successful registration, the user will then be granted access to use the social media site in step 1020.

In step 1025, the registered user can update their profile with additional personal information, and can determine which portions of that information are to be publically available to other members. In step 1030, the user can search the database for other members based on shared interests and/or cultural information. This information can be provided to the user in the form of a map, grid or listing, so as to enable easy access by the user.

In step 1035, the user can view the public profiles of the other members identified in step 1030, and send contact requests if so desired. In step 1040, if the contact request is accepted by the receiving member, the method can proceed to step 1045 where the two member profiles can be linked or otherwise associated so as to facilitate communication there between, and if the user chooses not to accept the communication request, the method can return to step 1030.

Aspects are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium and/or a non-transitory computer readable storage medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus, provide processes for implementing the functions/acts specified in the flowchart and/or block diagram block or blocks. As described herein, memory can also be non-transitory.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computer implemented method for establishing connections between users of a social media platform based on cultural information, the method comprising:
establishing communication between a processor enabled user interface, and an application system hosting a social media platform;
receiving data pertaining to a user of the user interface, said data including user identification and cultural information;
generating a user profile and user profile page based on the received data;
associating the user profile to a first group, said first group including other users having a location within a pre-defined geographic area;
granting the user interface access to a system database that includes one or more profile pages of other users of the social media platform;
receiving commands from the user interface via an input/output device to identify other users of the social media platform based on the other users cultural information; and
establishing communication between the granted user interface and the identified other users.

2. The method of claim 1, further comprising:
displaying a map that includes the geographic location of the other users of the first group.

3. The method of claim 1, wherein cultural information includes at least one of a user's nationality, languages spoken, religion, race and ethnicity.

4. The method of claim 1, further comprising:
generating a list of suggested friends and displaying the same onto the user profile page, wherein the list is generated by the application server and includes a comparison of the cultural information provided by all network users.

5. The method of claim 1, further comprising:
generating one or more categories of interest groups and displaying the same onto the user profile page, each of said categories including a list of network users that share a particular interest.

6. The method of claim 1, further comprising:
associating the user profile to at least one interest group, and displaying a map that includes the geographic location of the other network users that are also associated with the interest group.

7. The method of claim 1, further comprising:
generating a search screen and displaying the same onto the user interface, said search screen being configured to receive commands for searching the database for network users based solely on the network users cultural information.

8. The method of claim 7, further comprising:
displaying the result of the search in the form of a map, and identifying the geographic location of the identified users.

9. The method of claim 1, wherein social media platform includes a social media website.

10. A system, comprising:
a non-transitory memory for storing data; and
an application system having at least one processor that is programmed or structured to host a social media platform,
establish communication with a processor enabled user interface,
receive data pertaining to a user of the user interface, said data including user identification and cultural information,
generate a user profile and user profile page based on the received data,
associate the user profile to a first group, said first group including other users having a location within a pre-defined geographic area,
grant the user interface access to the non-transitory memory, said memory including one or more profile pages of other users of the social media platform,
receive commands from the user to identify other users of the social media platform based on the other users cultural information, and
establish communication between the granted user interface and the identified other users; and
at least one input/output device configured to transmit and receive the data across a network.

11. A non-transitory computer readable storage medium encoded with instructions, which when executed by a processor, causes the processor to perform a method comprising:
establishing communication between a processor enabled user interface, and an application system hosting a social media platform;
receiving data pertaining to a user of the user interface, said data including user identification and cultural information;
generating a user profile and user profile page based on the received data;
associating the user profile to a first group, said first group including other users having a location within a pre-defined geographic area;
granting the user interface access to a system database that includes one or more profile pages of other users of the social media platform;
receiving commands from the user interface via an input/output device to identify other users of the social media platform based on the other users cultural information; and
establishing communication between the granted user interface and the identified other users.

12. The computer readable storage medium of claim 11, further comprising:
displaying a map that includes the geographic location of the other users of the first group.

13. The computer readable storage medium of claim 11, wherein cultural information includes at least one of a user's nationality, languages spoken, religion, race and ethnicity.

14. The computer readable storage medium of claim 11, further comprising:
generating a list of suggested friends and displaying the same onto the user profile page, wherein the list is generated by the application server and includes a comparison of the cultural information provided by all network users.

15. The computer readable storage medium of claim 11, further comprising:
generating one or more categories of interest groups and displaying the same onto the user profile page, each of said categories including a list of network users that share a particular interest.

16. The computer readable storage medium of claim 11, further comprising:
associating the user profile to at least one interest group, and displaying a map that includes the geographic location of the other network users that are also associated with the interest group.

17. The computer readable storage medium of claim 11, further comprising:
generating a search screen and displaying the same onto the user interface, said search screen being configured to receive commands for searching the database for network users based solely on the network users cultural information.

18. The computer readable storage medium of claim 17, further comprising:
displaying the result of the search in the form of a map, and identifying the geographic location of the identified users.

19. The computer readable storage medium of claim 11, wherein social media platform includes a social media website.
